(19) United States
(12) Patent Application Publication
(10) Pub. No.: US 2016/0171404 A1
(43) Pub. Date: Jun. 16, 2016

(54) SYSTEM AND METHOD FOR STAFFING EMPLOYEES ON A PROJECT

(71) Applicant: XEROX CORPORATION, Norwalk, CT (US)

(72) Inventors: Koyel Mukherjee, Bangalore (IN); Atul Singh, Bangalore (IN); Partha Dutta, Bangalore (IN); Koustuv Dasgupta, Bangalore (IN)

(21) Appl. No.: 14/568,587

(22) Filed: Dec. 12, 2014

(51) Int. Cl. G06Q 10/06

(52) U.S. Cl. CPC G06Q 10/06313; G06Q 10/063112

(57) ABSTRACT

According to embodiments illustrated herein, there is provided a method for staffing one or more employees on a project. The method includes selecting a first set of employees from the one or more employees for a skill required to process the project, based on at least a first score and a second score. The method further includes receiving an input from a computing device deterministic of at least cost of the project, wherein the input is received through a graphical user interface (GUI) presented on the computing device. The method further includes selecting a second set of employees from the first set of employees based on at least one of a cost of each employee in the first set of employees, a time duration of the project, and the cost of the project.

### TECHNICAL FIELD

The presently disclosed embodiments are related, in general, to human resource management systems. More particularly, the presently disclosed embodiments are related to methods and systems for staffing one or more employees on a project.

### BACKGROUND

Current organizations in market offer myriad and complex products and services. To support these services, the organization may initiate one or more projects that may require employees having appropriate skills to work on the one or more projects. Usually, the employees are staffed on such projects based on their respective availability and the skills. In certain scenarios, an employee staffed on a certain project may leave the organization (due to a better career opportunity). Such attrition of employees may hamper the execution of the project, which may lead to a violation of the SLA associated with the project. Therefore, there is a need for a robust staffing solution.

### SUMMARY

According to embodiments illustrated herein, there is provided a method for staffing one or more employees on a project. The method includes selecting, by one or more processors, a first set of employees from the one or more employees for a skill required to process the project, based on at least a first score and a second score. The first score is a measure of attrition likelihood associated with each of the one or more employees for the skill, and the second score corresponds to at least a time expendable by each of the one or more employees on the project. The method further includes receiving, by a transceiver, an input from a computing device deterministic of at least cost of the project, wherein the input is received through a graphical user interface (GUI) presented on the computing device. The method further includes selecting, by the one or more processors, a second set of employees from the first set of employees based on at least one of a cost of each employee in the first set of employees, a time duration of the project, and the cost of the project. The method further includes transmitting, by the transceiver, the second set of employees and a cost of staffing the second set of employees on the project to the computing device, wherein the second set of employees is presented on a display screen associated with the computing device through the GUI.

According to embodiments illustrated herein, there is provided a system for staffing one or more employees on a project. The system includes a transceiver configured to receive an input from a computing device deterministic of at least a cost of the project, wherein the input is received through a graphical user interface (GUI) presented on the computing device. The system further includes one or more processors configured to select a first set of employees from the one or more employees for a skill required to process the project, based on at least a first score and a second score. The first score is a measure of attrition likelihood associated with each of the one or more employees for the skill, and the second score corresponds to at least a time expendable by each of the one or more employees on the project. The one or more processors is further configured to select a second set of employees from the first set of employees based on at least one of a cost of each employee in the first set of employees, a time duration of the project, and the cost of the project.

According to embodiments illustrated herein, there is provided a computer program product for use with a computer. The computer program product includes a non-transitory computer readable medium. The non-transitory computer readable medium stores a computer program code for staffing one or more employees on a project. The computer program code is executable by one or more processors configured to select a first set of employees from the one or more employees for a skill required to process the project, based on at least a first score and a second score. The first score is a measure of attrition likelihood associated with each of the one or more employees for the skill, and the second score corresponds to at least a time expendable by each of the one or more employees on the project. The computer program code is executable to receive, by a transceiver, an input from a computing device deterministic of at least a cost of the project, wherein the input is received through a graphical user interface (GUI) presented on the computing device. The computer program code is further executable to select, by the one or more processors, a second set of employees from the first set of employees based on at least one of a cost of each employee in the first set of employees, a time duration of the project, and the cost of the project. The computer program code is executable to transmit, by the transceiver, the second set of employees and a cost of staffing the second set of employees on the project to the computing device, wherein the second set of employees is presented on a display screen associated with the computing device through the GUI.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating a system for staffing employees on a project, in accordance with at least one embodiment;

FIG. 3 is a flowchart illustrating a method for staffing employees on a project, in accordance with at least one embodiment;

FIG. 4 is a flowchart illustrating a method for selecting a second set of employees so as to minimize cost of a project using a cost optimization algorithm, in accordance with at least one embodiment;

FIG. 5 is a flowchart illustrating a method for selecting a second set of employees so as to minimize cost of the project using a time-cost optimization algorithm, in accordance with at least one embodiment;

FIG. 6A is a block diagram illustrating a GUI displaying details of an employee, in accordance with an embodiment.

FIG. 6B is a block diagram illustrating a GUI utilized by a first user to input the details of a project, in accordance with an embodiment.

FIG. 6C is a block diagram illustrating a GUI utilized by a first user to input a one or more constraints associated with a project, in accordance with an embodiment.

FIG. 6D is a block diagram illustrating a GUI utilized by a first user to staff employees on a project, in accordance with an embodiment.

FIG. 6E is a block diagram illustrating a GUI utilized by a first user to pre-select an employee for a project, in accordance with an embodiment.

FIG. 6F is a block diagram illustrating a GUI utilized by a first user to change an attrition probability of potential employees, in accordance with an embodiment.

FIG. 6G is a block diagram illustrating a GUI displaying staffing of employees on a project, in accordance with an embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a device that includes one or more processors/microcontrollers and/or any other electronic components, or a device or a system that performs one or more operations according to one or more programming instructions/codes. Examples of the computing device may include, but are not limited to, a desktop computer, a laptop, a personal digital assistant (PDA), a mobile device, a Smartphone, a tablet computer (e.g., iPad®, and Samsung Galaxy Tab®), and the like.

An “organization” refers to a group of people, who work together to achieve a predetermined goal. In an embodiment, the organization may include one or more teams that may further include one or more employees. Each of the one or more teams may have respective goals.

A “user” refers to an individual who utilizes a computing device to perform one or more operations such as staffing one or more employees on a project. In an embodiment, the user may include a worker, a manager, a project manager, a staffing manager, and/or a hiring manager associated with a project at an organization.

A “project” refers to a set of inter-related tasks planned for execution over a period of time under one or more cost/budget constraints.

A “headcount” refers to a number of people/employees required for processing the project. In an embodiment, the headcount may be determined for each skill required to process a project. For example, a project requires 5 employees having C++ programming skills and two employees having Java programming skills.

“One or more attributes associated with a project” refers to one or more requirements or properties of the project. In an embodiment, the one or more attributes may comprise the information required for processing the project. In an embodiment, the one or more attributes of the project may comprise, but are not limited to, business constraints, location constraints, skill required for processing the project, duration of the project, and headcount of the project for each skill.

“Business constraints” refers to one or more conditions governing processing of the project by one or more employees. In an embodiment, the business constraints may include information pertaining to a conflict of interest. For example, an employee is assigned to a project having a conflict of interest with a project on which the employee is currently staffed. Such an employee may not be assigned to the project.

“Attrition history” refers to a record of an employee at one or more previous organizations. In an embodiment, the attrition history includes the record of tenure that an employee spent in the one or more previous organizations.

“Fractional allocation” refers to a fractional assignment of an employee on one or more projects. In an embodiment, the fractional allocation of the employee lies between 0 and 1. The employee having fractional allocation as 0 implies that the employee is not allocated/staffed to any project. Similarly, the employee shaving fractional allocation as 1 implies that the employee are fully allocated/staffed on the projects and is not available for any new project. For instance, if the fractional allocation of an employee on a project is 0.50, the employee will spent 50% of his time on the project.

“Employee performance indicator (EPI)” refers to an index indicative of a performance of an employee on previous projects in an organization. Hereinafter, the term “EPI” is interchangeably referred as “third score.”

“First score” refers to a measure of attrition probability of an employee. In an embodiment, the first score is determined based on an attrition history of an employee.

“Second score” refers to a fractional allocation an employee on a project.

“First threshold value” refers to a maximum permissible value of the first score of an employee for the employee to be selected/staffed on a project.

“Second threshold value” refers to a minimum permissible value of the second score of an employee for the employee to be selected/staffed on a project. In an embodiment, the fractional allocation of the employees on the project may be in multiples of the second threshold value.

A “tolerance value” refers to a time-cost tradeoff value associated with a project. In an embodiment, the tolerance value may be set by a user. In an embodiment, the tolerance value is determined based on the position of the slider on a time-cost slider.

“Copies of an employee” refer to various fractional allocations of an employee on one or more projects. For example, the employee is ⅓ fractionally allocated on three projects. In such a scenario, a separate copy of the employee is said to be allocated on each of the three projects.

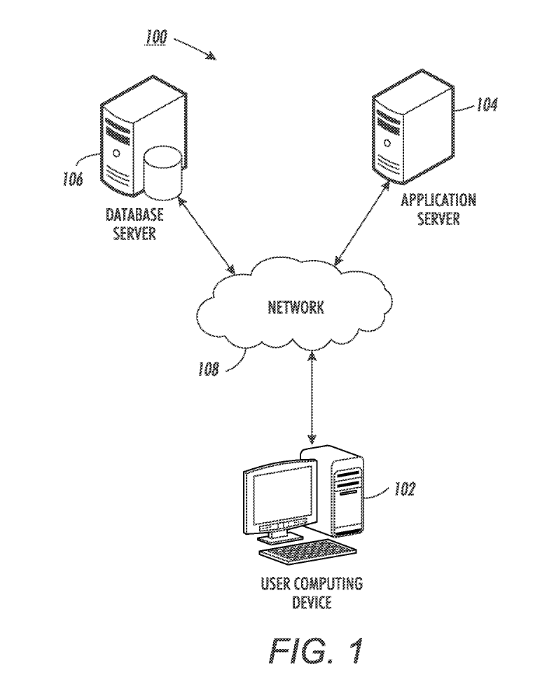

FIG. 1 is a block diagram illustrating a system environment 100 in which various embodiments may be implemented. The system environment 100 includes a user computing device 102, an application server 104, a database server 106, and a network 108. Various devices in the system environment 100 may be interconnected over the network 108. FIG. 1 shows, for simplicity, one user computing device 102, one application server 104, and one database server 106. However, it will be apparent to a person having ordinary skill in the art that the disclosed embodiments may also be implemented using multiple user computing devices 102, multiple application servers 104, and multiple database servers 106.

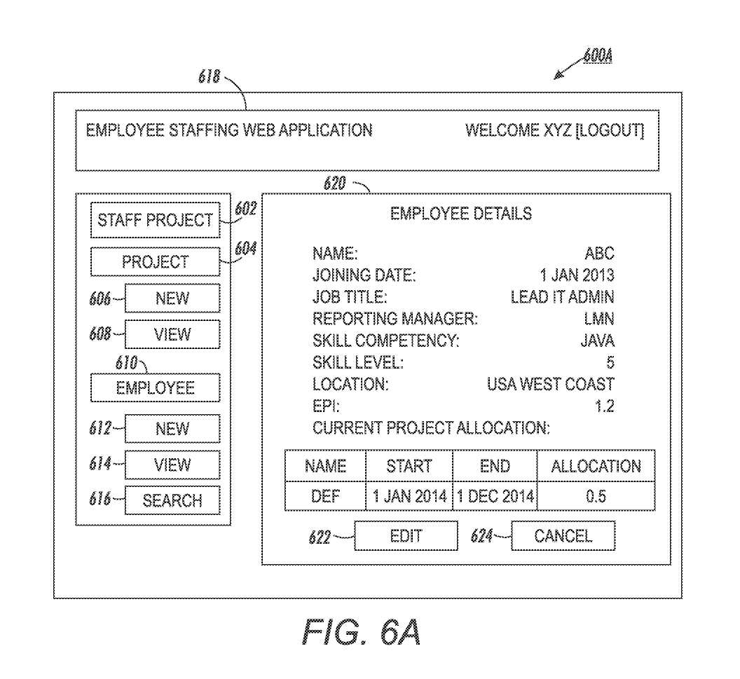

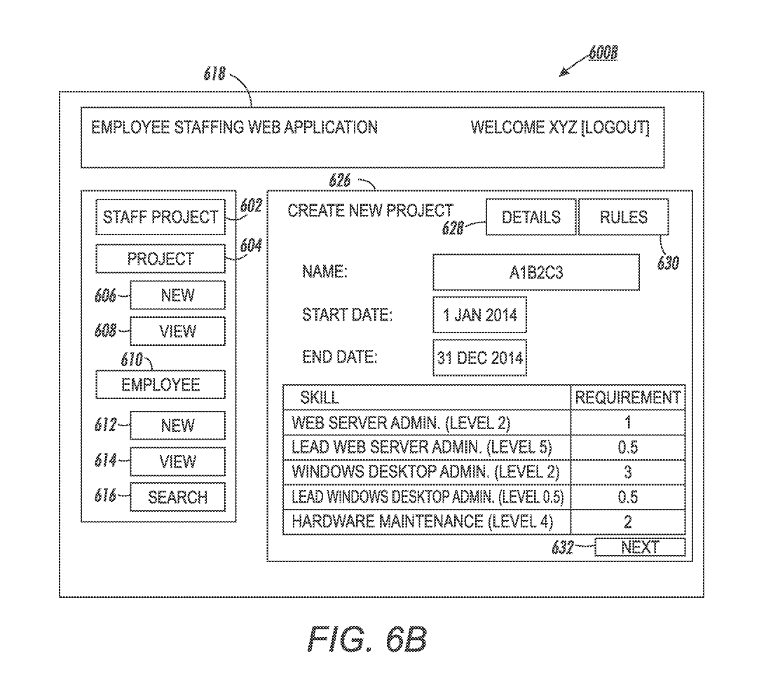

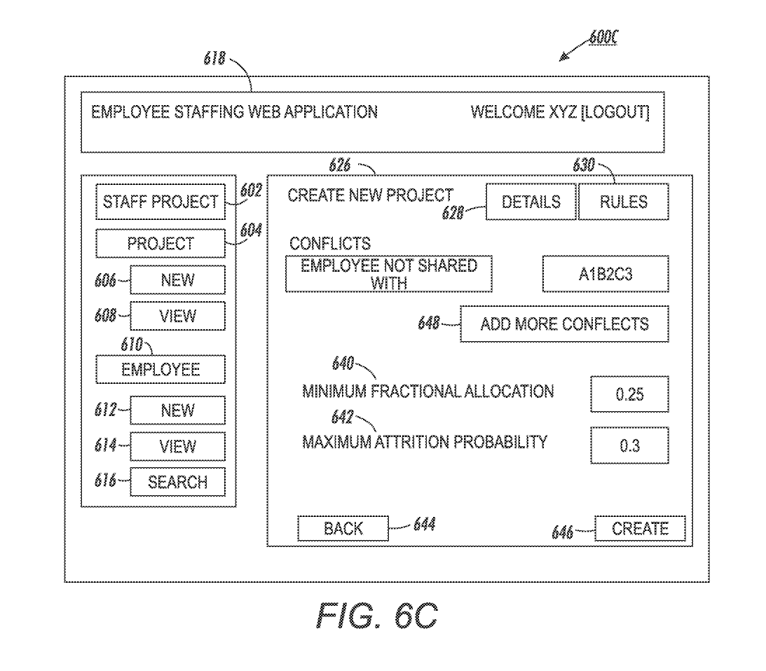

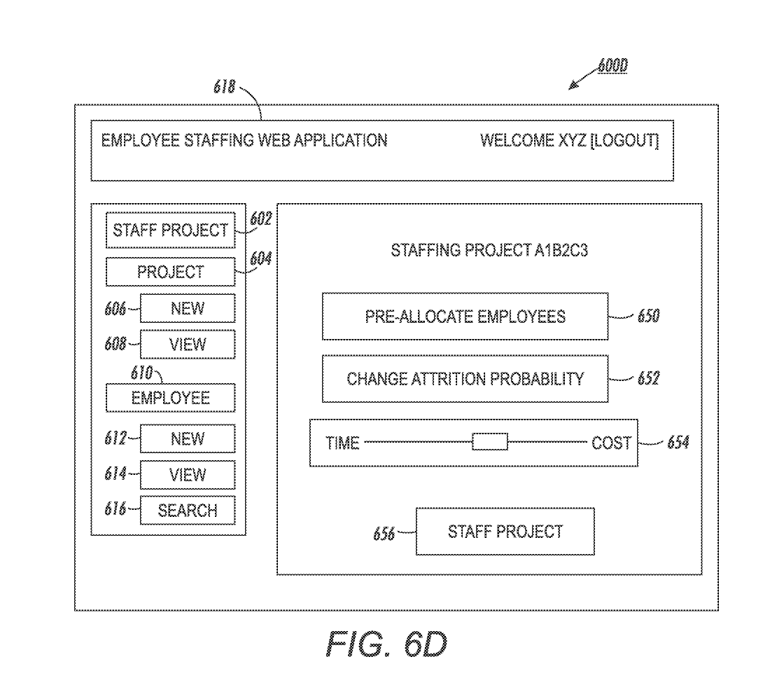

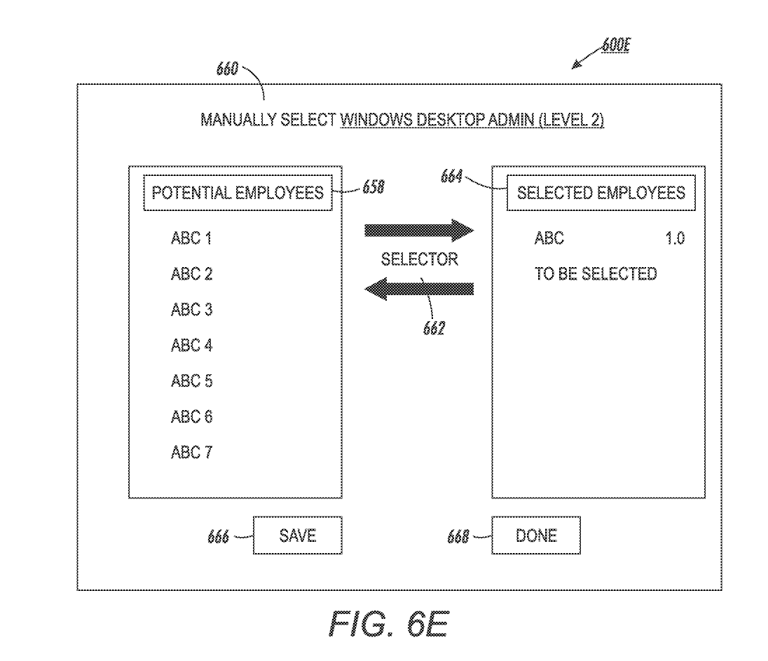

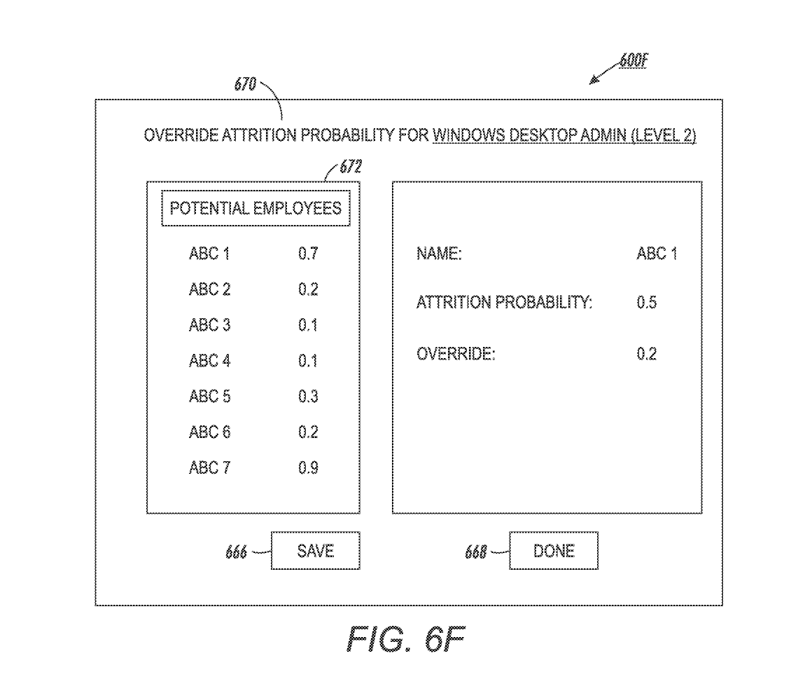

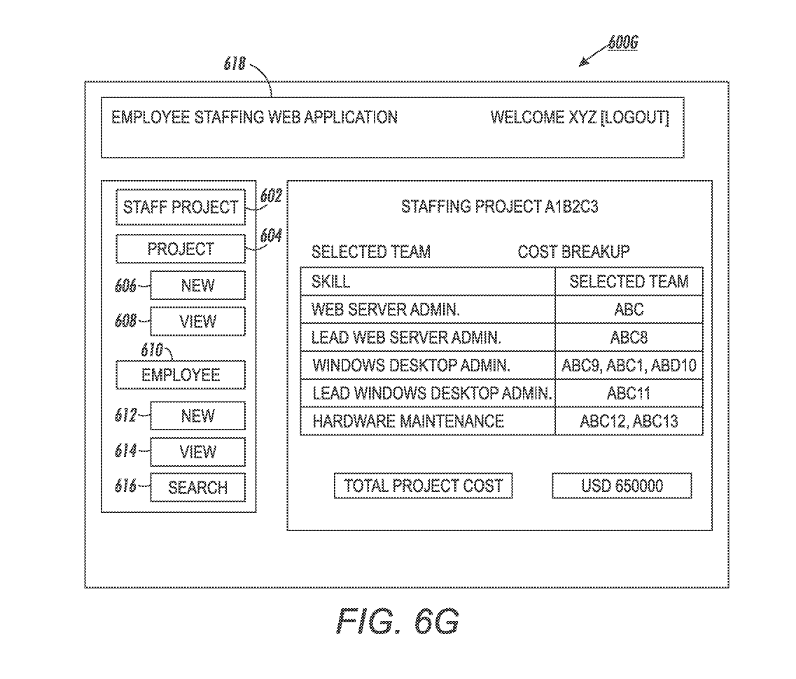

The user computing device 102 refers to a computing device used by a first user. In an embodiment, the first user may correspond to at least one of, but is not limited to, one or more managers, one or more project managers, and one or more hiring managers. The user computing device 102 may comprise one or more processors in communication with one or more memories. The user computing device 102 may be operable to execute one or more sets of instructions stored in the one or more memories. In an embodiment, the user computing device 102 may comprise a display screen that may be configured to display one or more user interfaces to the first user. In an embodiment, the user computing device 102 may be communicatively coupled over the network 108. In an embodiment, the first user may utilize the user computing device 102 to transmit/receive one or more attributes associated with a project to/from the application server 104 and/or the database server 106 over the network 108. For example, the first user may transmit, using the user computing device 102, the one or more attributes such as, but are not limited to, one or more skills required for processing the project, one or more business constraints associated with an organization, a headcount of the one or more employees required for processing the project, one or more location constraints associated with the project, duration of the project, and a historical data of the one or more employees such as an attrition history, a performance and an evaluation history, and an allocation history. The first user may utilize the one or more user interfaces to transmit/receive the one or more attributes. Further, the user computing device 102 may receive a list of employees that may be staffed on the project. In an embodiment, the first user may utilize the one or more user interfaces to pre-select an employee for the project. The one or more user interfaces have been described later in conjunction with FIGS. 6A-6G. The user computing device 102 may include various types of computing devices such as, but not limited to, a desktop computer, a laptop, a personal digital assistant (PDA), a mobile device, a Smartphone, a tablet computer (e.g., iPad® and Samsung Galaxy Tab®), and the like.

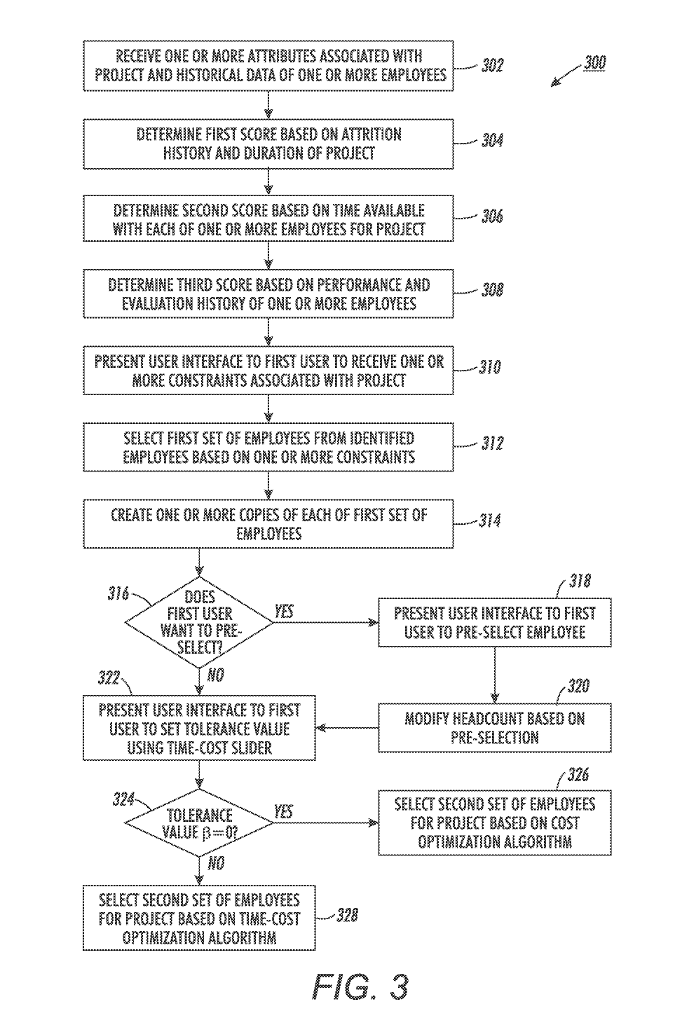

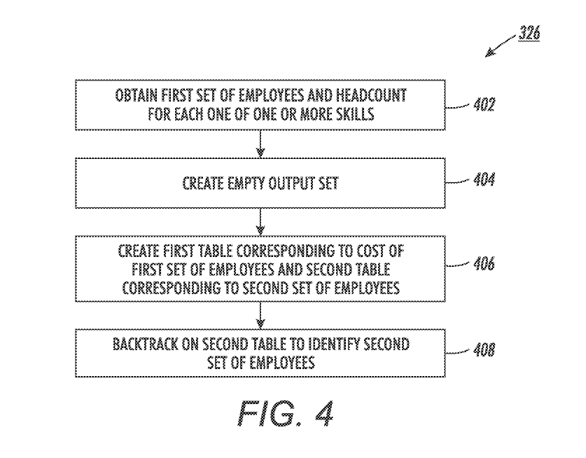

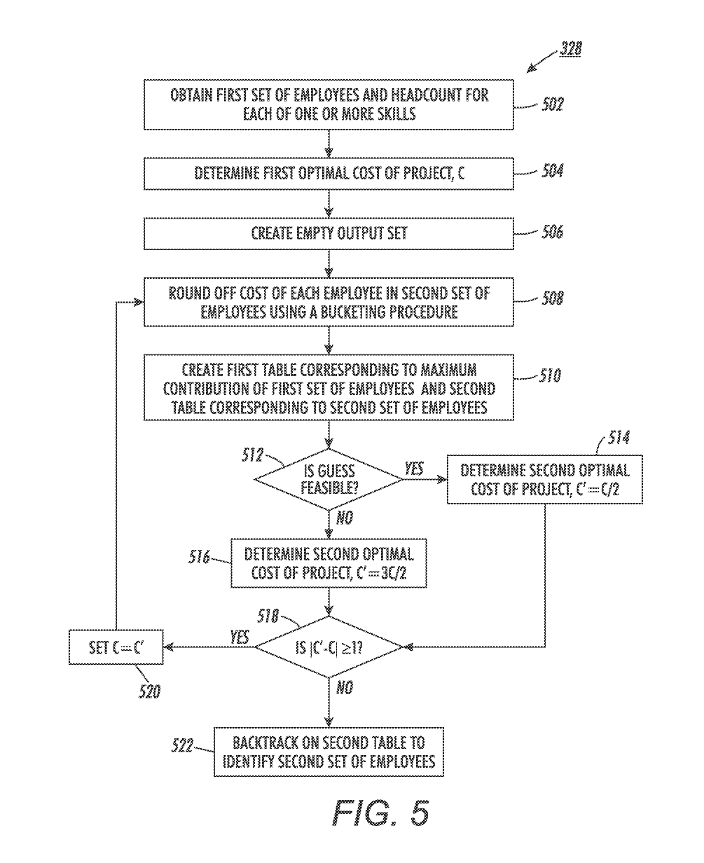

The application server 104 may refer to a computing device or a software framework that may provide a generalized approach to create the application-server implementation. In an embodiment, the function of the application server 104 may be dedicated to the efficient execution of procedures such as, but not limited to, programs, routines, or scripts stored in the one or more memories for supporting its applied applications. In an embodiment, the first user may access the application server 104 over the network 108 to submit the one or more attributes pertaining to the project (e.g., through a web-based interface). In an embodiment, the application server 104 may further extract the historical data associated with the one or more employees of the organization from the database server 106 over the network 108. In an embodiment, the application server 104 may select a first set of employees from the one or more employees based on the one or more attributes associated with the project and the historical data associated with each of the one or more employees. The selection of the first set of employees has been described later in conjunction with FIG. 3. Further, the application server 104 may select a second set of employees from the first set of employees based on a time and a cost of the project. The selection of the second set of the employees has been described later in conjunction with FIG. 3, FIG. 4, and FIG. 5.

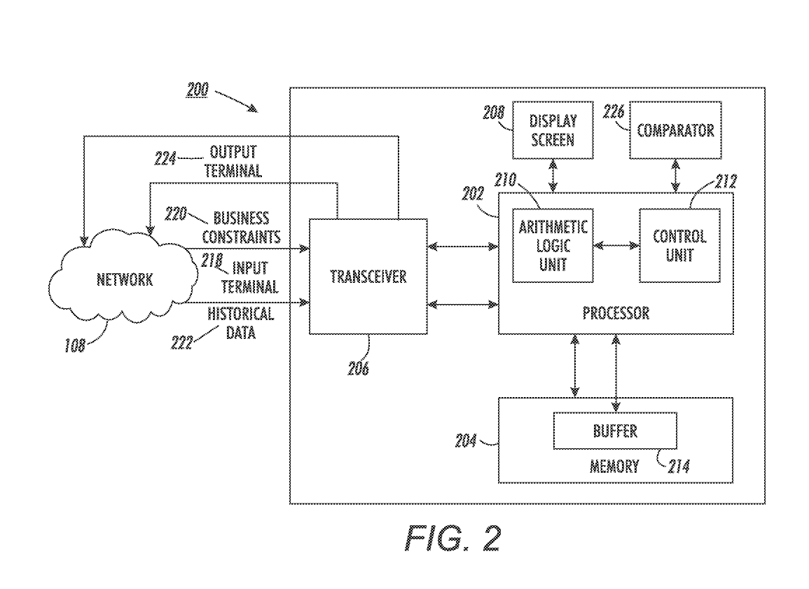

The application server 104 may be realized using various technologies such as, but not limited to, Java application server, .NET Framework, PHP, Base4 application server, and Appaserver. The application server 104 has been described later in conjunction with FIG. 2.

The database server 106 may refer to a computing device that may store the one or more attributes associated with the project. Further, the database server 106 may store the historical data of the one or more employees associated with the organization. In an embodiment, the historical data associated with the one or more employees may include the performance of the one or more employees on previously attempted projects, the attrition history associated with the one or more employees and the current allocation of the one or more employees on ongoing projects (different from the project under consideration).

In an embodiment, the database server 106 may be communicatively coupled over the network 108. In an embodiment, the database server 106 may be configured to transmit or receive one or more instructions/information/features to/from one or more devices, such as the user computing device 102, and the application server 104 over the network 108. In an embodiment, the database server 106 may receive a query from the application server 104 to retrieve the one or more attributes and the historical data. For querying the database server 106, one or more querying languages may be utilized such as, but are not limited to, SQL, QUEL, DMX and so forth. Further, the database server 106 may be realized through various technologies such as, but not limited to, Microsoft® SQL server, Oracle, and My SQL.

A person skilled in the art would understand that the scope of the disclosed invention should not be limited to the database server 106 or the application server 104 as a separate entity. In an embodiment, the functionalities of the database server 106 and the application server 104 may be combined into a single server, without limiting the scope of the inventions.

The network 108 corresponds to a medium through which content and messages may flow between one or more of, but not limited to, the user computing device 102, the application server 104, and the database server 106. Examples of the network 108 may include, but are not limited to, a Wireless Fidelity (Wi-Fi) network, a Wide Area Network (WAN), a Local Area Network (LAN), or a Metropolitan Area Network (MAN). Various devices such as the user computing device 102, the application server 104 and the database server 106, may connect to the network 108 in accordance with various wired and wireless communication protocols such as Transmission Control Protocol/Internet Protocol (TCP/IP), User Datagram Protocol (UDP), and 2G, 3G, or 4G communication protocols.

FIG. 2 is a block diagram illustrating a system 200 for staffing the employees on the project, in accordance with at least one embodiment. The system 200 may comprise one or more processors, such as a processor 202, one or more memories, such as a memory 204, one or more transceivers, such as a transceiver 206, one or more display screens, such as a display screen 208, one or more comparators, such as a comparator 226, one or more arithmetic logic units, such as an arithmetic logic unit 210, and one or more control units, such as a control unit 212. The memory 204 comprises at least a buffer 214. The transceiver 206 is coupled to an input terminal 218 and an output terminal 224.

The system 200 may correspond to the application server 104 or the user computing device 102 without departing from the scope of the disclosure. For the purpose of the ongoing description, the system 200 has been considered as the application server 104.

The processor 202 may be configured to execute a set of instructions stored in the memory 204. The processor 202 may be coupled to the memory 204, the transceiver 206, the display screen 208, and the comparator 226. The processor 202 may comprise the arithmetic logic unit 210 and the control unit 212. The arithmetic logic unit (ALU) 210 may be coupled to the control unit 212. The ALU 210 may be operable to perform one or more mathematical and logical operations and the control unit 212 controls the operation of the ALU 210. The processor 202 may execute a set of instructions/programs/codes/scripts stored in the memory 204 to perform the one or more operations. The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store one or more sets of instructions and data. In an embodiment, the memory 204 may include the buffer 214. The buffer 214 may store the one or more attributes associated with the project. The buffer 214 may further store the historical data of the one or more employees. Some of the commonly known memory implementations include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations. It will be apparent to a person having ordinary skill in the art that the one or more instructions stored in the memory 204 enables the hardware of the system 200 to perform the predetermined operation.

The transceiver 206 may be operable to communicate with the one or more devices, such as the user computing device 102, and/or one or more servers, such as the database server 106 over the network 108. The transceiver 206 may be operable to transmit and receive the one or more attributes and one or more responses to/from various components of the system environment 100. In an embodiment, the transceiver 206 is coupled to the input terminal 218 and the output terminal 224 through which the transceiver 206 may receive and transmit data/messages, respectively. In an embodiment, the input terminal 218 and the output terminal 224 may be realized through, but not limited to, an antenna, an Ethernet port, an USB port or any other port that can be configured to receive and transmit data. The transceiver 206 may transmit and receive data/messages in accordance with various communication protocols such as, TCP/IP, UDP, and 2G, 3G, or 4G communication protocols through the input terminal 218 and the output terminal 224.

In operation, the transceiver 206 may receive the one or more attributes pertaining to the project and the historical data of the one or more employees from the user computing device 102 or the database server 106 through the input terminal 218. The transceiver 206 may store the one or more attributes pertaining to the project and the historical data of the one or more employees in the buffer 214. Further, the transceiver 206 may transmit the list of the first set of employees and the second set of employees to the user computing device 102 through the output terminal 224.

The display screen 208 may comprise suitable logic, circuitry, interfaces, and/or code that may be configured to display the one or more responses through the one or more interfaces. The display screen 208 may be further operable to render one or more features, information, and/or applications of the user computing device 102 or the application server 104. The display screen 208 may be realized through several known technologies such as, but not limited to, Liquid Crystal Display (LCD) display, Light Emitting Diode (LED) display, Organic LED (OLED) display technology, and/or the like.

The comparator 226 is configured to compare at least two input signals to generate an output signal. In an embodiment, the output signal may correspond to either ‘1’ or ‘0’. In an embodiment, the comparator 226 may generate output ‘1’ if the value of a first signal (from the at least two signals) is greater than a value of the second signal (from the at least two signals). Similarly, the comparator 226 may generate an output ‘0’ if the value of the first signal is less than the value of the second signal. In an embodiment, the comparator 226 may be realized through either software technologies or hardware technologies known in the art. Though, the comparator 226 is shown outside the processor 202 in FIG. 2, a person skilled in the art would appreciate that the comparator 226 may be implemented inside the processor 202 without departing from the scope of the disclosure.

FIG. 3 is a flowchart 300 illustrating a method for staffing the employees on the project, in accordance with at least one embodiment. The flowchart 300 is described in conjunction with FIG. 1 and FIG. 2.

At step 302, the one or more attributes associated with the project are received. In an embodiment, the processor 202 may receive the one or more attributes associated with the project from the user computing device 102. In an embodiment, the first user may send a request to staff the one or more employees on the project. The request may include the one or more attributes associated with the project. In an embodiment, the one or more attributes may include the one or more skills required for processing the project, the one or more business constraints associated with the organization, the headcount of the one or more employees required for processing the project, the one or more location constraints associated with the project, and the duration of the project.

A person having ordinary skill in the art would understand that a project may require employees of different skills to work together. For example, a project to set up a computer network may require a person having computer networking skills, a person having network security skills, etc. Further, the headcount of the employees required for a particular skill may vary. For instance, the project to set up the computer network may require five employees having the computer networking skills and two employees having the network security skills.

In an embodiment, the business constraint associated with the project may comprise the information pertaining to the conflict of interest. For instance, an employee working on a project for “X” bank may not be suitable to work on a project received from “Y” bank, as there may exist a conflict of interest between “X” bank and “Y” bank. In an embodiment, the one or more business constraints may include a list of such companies that may have the conflict of interest. A person having ordinary skill in the art would understand that the scope of the disclosure is not limited to the business constraints having information pertaining to the conflict of interest only. In an embodiment, the business constraints may include other information such as certification or security clearance of the one or more employees who may be allowed to work on the project. In another embodiment, the business constraints may include allowing sharing of the one or more employees among the one or more projects from the same customer.

Post receiving of the request, the processor 202 may extract the historical data associated with the one or more employees by sending a query to the database server 106. In an embodiment, the query is transmitted using the transceiver 206 through the output terminal 224 over the network 108.

In an embodiment, the historical data associated with the one or more employees may comprise, but are not limited to, the attrition history, and the performance and the evaluation history on the previous projects, and the allocation history.

In an embodiment, the attrition history may include information pertaining to the previous employers/organization of the each of the one or more employees. Further, the attrition history may include the duration spent by the employee in each of the previous organizations.

In an alternate embodiment, the attrition history associated with the employee may correspond to a log of incomplete projects. In an embodiment, the incomplete projects correspond to projects in which the employee may not have completed the task allocated to him/her. Such projects are mentioned in the attrition history of the employee. Further, the attrition history may include the log of total time spent by the employee on such incomplete projects and total time that may have been allocated to the employee on such projects. In some scenarios, the employee may have spent more time than allocated time on the project that was left incomplete by the employee. In such scenario, a log of percentage of task project completed by the employee is maintained in the attrition history. In an embodiment, the percentage of the task completed by the employee may be determined by the project manager of the project (i.e., the first user). Further, the attrition history includes the log of skills for which the employee was staffed on the incomplete projects.

Post reception of the one or more attributes and the historical data, the processor 202 may identify the employees possessing the skills required to work on the project. For example, the one or more skills required to work on the project includes C++, Java, and computer networking. Further, let the number of employees associated with an organization is 100. Out of 100 employees, 20 employees are C++ programmers, 5 employees are Java programmers, and 15 employees are computer networking professionals. Thus, out of 100 employees, the processor 202 will identify 40 employees (20 C++ programmers, 5 Java programmers, and 15 computer networking professionals) having skills suitable for the project. Further, the identified employees are filtered such that there does not exist any conflict of interest with respect to other projects that the identified employees are working on.

At step 304, a first score is determined for each of the identified employees based on respective attrition history and the duration of the project under consideration. In an embodiment, the ALU 210 may determine the first score. In an embodiment, the first score is a measure of attrition likelihood associated with each of the identified employees.

As discussed, the processor 202 may receive project duration as one of the attribute of the project from the user computing device 102. Further, the processor 202 may determine a distribution parameter for each of the identified employees based on the respective attrition history. For example, a first employee has worked in three organizations previous to the current organization. The average time spent in each of the previous organizations by the first employee is three years. Similarly, a second employee has on an average spent around two years in each of the previous organizations. Therefore, the value of distribution parameter for the first employee may be less than the value of the distribution parameter for the second employee, as there is a high probability that the second employee may leave the current organization after two years.

A person having ordinary skill in the art would understand that the scope of the disclosure is not limited to determining the distribution parameter for each of the identified employees separately. In an embodiment, the distribution parameter for a class of employees may be determined. In an embodiment, the class of employees may include employees having similar skills. For instance, 20 C++ programmers may constitute a first class of employees and a distribution parameter may be determined for the first class of employees. Similarly, five java programmers may constitute a second class of employees and a distribution parameter may be determined for the second class of employees. In such a scenario, an average time spent by each employee in a class of employees, in respective previous organizations is determined. Based on the average time spent, the processor 202 may determine the distribution parameter for the class of employees.

Thereafter, the processor 202 may utilize the following equation to determine the attrition probability (i.e., first score) associated with the identified employees:

first score=1−e^{-λ}^{_{i·}}^{ρ}^{ₜ} (1)

where,

λᵢ: Distribution parameter for employee i; and

ρₜ: Project duration.

At step 306, a second score is determined based on an availability of each of the identified employees for the project. In an embodiment, the ALU 210 may determine the second score based on the time available with each of the identified employees for the project. In an embodiment, the processor 202 may determine current allocation of the identified employees on one or more ongoing projects.

For example, a first employee is currently working on two ongoing projects. Further, the first employee has 2100 hours of time available in a year. The two ongoing projects require the first employee to spend 1050 hours and 200 hours respectively. Therefore, total time available with the first employee to work on other projects is 850 hours. The second score associated with the first employee is 850/2100 i.e., approx. 0.405. In an embodiment, the processor 202 may utilize following equation to determine the second score:

$$second score = \frac{\begin{matrix}( total time available in the year ) - \\ ( time on on going projects )\end{matrix}}{total time available in the year} \qquad ( 2 )$$

In an embodiment, the second score corresponds to the fractional allocation of the identified employees on the project. In an embodiment, the fractional allocation of the one or more employees lies between 0 and 1. The one or more employees having fractional allocation as 0 implies that the one or more employees are not allocated/staffed to any project. Similarly, the one or more employees having fractional allocation as 1 implies that the one or more employees are fully allocated/staffed on the one or more previous projects and are not available for any new project.

At step 308, a third score is determined based on the performance and the evaluation history of the identified employees. In an embodiment, the ALU 210 may determine the third score. In an embodiment, the third score may correspond to an employee performance indicator (EPI). In an embodiment, the processor 202 may extract the performance and the evaluation history of the one or more employees from the user computing device 102 or database server 106 over the network 108. In an embodiment, the performance and the evaluation of the one or more employees may be denoted as a real number. The EPI of the employee i may denoted by a real number αᵢ ∈ [0,1] which may be obtained from the organization. In a scenario, wherein the performance and evaluation of the employees is not available, the EPI may be set to 1 by default.

At step 310, a user interface is presented to the first user to receive input of one or more constraints associated with the project. In an embodiment, the processor 202 may present the user interface to the first user through the user computing device 102. In an embodiment, the first user may utilize the user interface to provide inputs pertaining to the one or more constraints/rules associated with the project to filter the first set of employees from the identified employees. In an embodiment, the one or more constraints/rules may include, but are not limited to, a threshold value for the first score, the second score, and the third score.

At step 312, the first set of employees are selected based on the one or more constraints. In an embodiment, the processor 202 may select the first set of employees. As discussed above, each of the identified employees has an associated first score value (attrition probability), the second score value (fractional allocation or availability of the identified employees) and the third score value (EPI). Further, as discussed in step 310, the first user may provide the input pertaining to the one or more constraints (i.e., threshold value). The processor 202 may transmit the values of the first score, the second score, the third score associated with an identified employee to the comparator 226. Further, the processor 202 may transmit the threshold values associated with the first score, the second score and the third score to the comparator 226. Thereafter, the comparator 226 may compare the values of the first score, the second score and the third score, with corresponding threshold values to determine if the value of the first score, the second score, and the third score are greater than corresponding threshold values. If it is determined that the values of the first score, the second score, and the third score are greater than the respective threshold values, the identified employees may be selected as the first set of employees. Else, the identified employees may not be considered for being staffed on the project.

A person having ordinary skill in the art would understand that the scope of the disclosure is not limited to selecting an employee, if the values of the associated first score, the second score, and the third score are greater than the corresponding threshold values. In an embodiment, the employee may be selected as a part of the first set of employees if values of the first score, the second score, and the third score are less than or equal to the corresponding threshold values.

The selection of the first set of employees based on the one or more constraints ensure that only those employees that satisfy the minimum constraints set by the first user get selected as the first set of employees. For instance, the first set of employees may include employees who will be able to spend enough time on the project. Further, the performance of such employees, as recorded till date, is in accordance to the standards set by the first user. Additionally, the employees, so selected, may be less probable to leave the organization in comparison to the employees that were filtered out.

In an embodiment, only those employees, having the value of the first score, the second score, and third score exceeding the corresponding threshold values, are selected as the first set of employees. In an alternate embodiment, employees, having at least two of the first score, the second score, and third score exceeding the corresponding threshold values, are selected as the first set of employees. In an embodiment, the first user may provide an input pertaining to the scores that are of priority to the first user. Based on the priority, the first set of employees may be selected.

For example, the first user may provide an input that employee EPI score (i.e., third score) and the employees availability (i.e., second score) have high priority in comparison to the priority of the attrition probability score (i.e., first score). Thus, employees, having value of the second score and the third score exceeding the corresponding threshold values are selected as the first set of employees. Therefore, the first set of employees may include employees, whose first score may not have exceeded the threshold value (as the first score is not of importance to the first user). Similarly, the first user may provide input that only one of the first score, the second score and third score is of importance to the first user. Accordingly, the selection of the first set of employees may vary. In an embodiment, the ALU 210 may determine effective headcount of each of the first set of employees. In an embodiment, the ALU 210 may determine the headcount. In an embodiment, the headcount is determined based on the first score, the second score, and the third score associated with the each employee in the first set of employees. In an embodiment, the ALU 210 may utilize the following equation to determine the headcount:

effective headcount=(1−first score)*second score*third score (3)

At step 314, copies of each employee in the first set of employees are created. In an embodiment, the processor 202 may create the copies of each employee in the first set of employees based on at least the second threshold value and the second score. In an embodiment, the processor 202 may utilize following equation to create multiple copies of the employee i:

$$copies of employee i = \vert \frac{second score}{second threshold value} \vert \qquad ( 4 )$$

Further, the processor 202 may determine the cost and the headcount for each copy of the employee i. In an embodiment, the processor 202 may utilize following equation to determine the headcount and the cost of each copy of the employee i:

$$headcount of a copy of employee i = {α}_{i} * {p}_{i , ρ} * \frac{1}{k ( ρ )} \qquad ( 5 )$$

where,

αᵢ: EPI of the employee i;

p_{i,ρ}: Retention probability of the employee i with respect to a project ρ; and

$$\frac{1}{k ( ρ )} \text{:}$$

Minimum fraction, in multiple of which, employees may be assigned to a project ρ (second threshold value).

$$cost of a copy of employee i = {c}_{i} \cdot \frac{1}{k ( ρ )} \qquad ( 6 )$$

where,

cᵢ: Cost of employee i.

In an embodiment, the first set of employees are updated to include copies of each employee. Following table illustrates an example first set of employees including the copies of the employee:

TABLE 1
Example first set of employees including
the copies of the employee

| Employee | Headcount of a copy | Cost of a copy |
|---|---|---|
| Employee-1a | 0.25 | 3 |
| Employee-1b | 0.25 | 3 |
| Employee-2a | 0.3 | 4 |
| Employee-2b | 0.3 | 4 |
| Employee-2c | 0.3 | 4 |

As shown in Table 1, two copies are created for an employee-1 based on the second score of the employee-1 and the second threshold value (minimum fraction requirement) associated with a project. The headcount of the copies (employee-1a and employee-1b) of the employee-1 is 0.25 each. The cost of the copies (employee-1a and employee-1b) of the employee-1 is 3 each. Similarly, three copies are created for an employee-2 based on the second score of the employee-2 and the second threshold value (minimum fraction requirement) associated with a project. The headcount of the copies (employee-2a, employee-2b and employee-2c) of the employee-2 is 0.35 each. The cost of the copies (employee-2a, employee-2b and employee-2c) of the employee-2 is 4 each.

At step 316, a check is performed to determine if the first user wants to pre-select the one or more employees. In an embodiment, the processor 202 may send a notification to the first user over the one or more user interfaces. Thereafter, the user may provide an input indicative of whether the first user wants to pre-select an employee for the project. If at step 316, the processor 202 determines that the first user wants to pre-select the one or more employees, step 318 is performed. Otherwise, step 322 is performed.

At step 318, a user interface is presented to the first user to receive an input pertaining to a pre-selection of one or more employees. In an embodiment, the processor 202 may present the user interface to the first user on the user computing device 102 to pre-select the employee of his/her preferences. The first user may provide the input to pre-select the one or more employees from the updated first set of employees for the project. In an embodiment, the first user may select the employees (a full or a partial team) based on at least his/her past working experience with the one or more employees. The first user may select the employees based on his/her personal experience, or some external information about the one or more employees. In an embodiment, the first user may provide an input to modify the one or more skills of the pre-selected employees. In an embodiment, the first user may select the pre-selected employees for a particular skill.

At step 320, the headcount required for the project is modified. In an embodiment, the processor 202 may modify the headcount. As discussed above, that the first user may define the headcount for the project. In an embodiment, the headcount is indicative of the number of employees that are required to work on the project. In an embodiment, the first user may define the headcount for each of the one or more skills required for the project. On pre-selecting the employee for a particular skill, the processor 202 may accordingly update the headcount based on the effective headcount of the pre-selected employee. For instance, the headcount defined by the first user for a skill of the project is 2.5. Further, the first user may have further pre-selected an employee, whose effective headcount is 0.5. Therefore, the processor 202 modifies the headcount for the skill of the project to 2.

A person having ordinary skill in the art would understand that the first user may pre-select a copy of the employee (included in the updated first set of employees). In such a scenario, the cost and the headcount required on the project is updated based on the cost and the headcount associated with the copy of the pre-selected employee.

At step 322, a user interface is presented to the first user to receive an input, using a time-cost slider, to set a tolerance value. In an embodiment, the processor 202 may present the user interface to the first user through the user computing device 102 for setting the tolerance value using the time-cost slider. The first user may scroll through the time-cost slider to set the tolerance value, which may be utilized by the processor 202 to optimize cost and/or time of the project.

In an embodiment, the time-cost slider may allow the user to tradeoff between the cost of the project and the time/deadline of the project. In an embodiment, the cost of project may be indicative of the profit margin on the project. For example, the organization may receive a payment of 1000 USD on completion the project. The profit margin on the project is the different between payment received and cost or the CTC of the employees working on the project. Therefore, the organization may have less profit margin when employees having high associated cost work on the project, as compared to, when employees with low associated cost work on the project. However, the employees with high associated cost may be efficient and experienced, therefore, the project may get completed on time. Thus, there may exist a tradeoff between the cost of the project and time associated with completion of the project. In an embodiment, the position of the slider on the time-cost slider may be scaled to indicate a real number in the scale [0,1] which may represents the tolerance value. The tolerance value corresponding to the position of the slider on the time-cost slider may be represented by the real number β, wherein β ∈ [0,1]. In an embodiment, if the slider is positioned at value ‘1’, the first user wishes to complete the project on time. In such a scenario, Cost of the project is not an issue for the first user. Similarly, if slider is positioned at the value ‘0’, the first user wishes to earn maximum profit margin out of the project. The time or the deadline of the project is not an issue for the first user.

At step 324, a check is performed to determine if the tolerance value, β is equal to zero. In an embodiment, the processor 202 may perform the check to determine if the tolerance value, β is equal to zero. If at step 324, the processor 202 determines that the tolerance value, β is equal to zero, step 326 is performed. Otherwise, step 328 is performed.

At step 326, the second set of employees is selected based on a cost optimization algorithm (hereinafter, DP-OPT-Cost algorithm). In an embodiment, the processor 202 may select the second set of employees. The processor 202 utilizes the DP-OPT-Cost algorithm to select the second set of employees so as to optimize the cost of the project. The DP-OPT-Cost algorithm has been described later in conjunction with FIG. 4.

At step 328, the second set of employees is selected based on a time-cost optimization algorithm (hereinafter, FPTAS-Cost algorithm). In an embodiment, the processor 202 may select the second set of employees based on the FPTAS-Cost algorithm. The FPTAS-Cost algorithm has been described later in conjunction with FIG. 5.

The current project and its allocation are modified/updated for the second set of employees in the database server 106. In an embodiment, the processor 202 may modify/update profile of each of the second set of employees based on the current project and the current allocation.

FIG. 4 is a flowchart 324 illustrating a method for selecting the second set of employees so as to minimize the cost of the project using the DP-OPT-Cost algorithm, in accordance with at least one embodiment.

As discussed above, the DP-OPT-Cost algorithm is utilized when the position of the slider is on the ‘Cost’ end on the time-cost slider (i.e., value of the slider is 0). The process of selecting the second set of employees and optimizing the cost of the project using DP-OPT-Cost algorithm is described in conjunction with FIG. 1, FIG. 2, and FIG. 3.

At step 402, the updated first set of employees (selected in the step 312) and the headcount for each of the one or more skills (one of the attribute of the project input by the first user) are obtained. In an embodiment, the processor 202 may obtain the updated first set of employees E from the buffer 214. In an embodiment, the processor 202 may obtain the headcount H for each of the one or more skills required for processing the project.

At step 404, an empty output set is created. In an embodiment, the processor 202 may create the empty output set such as E′_{c}=φ such that E′_{c} ⊂ E. In an embodiment, the empty output set is populated with the second set of employees.

At step 406, a first table corresponding to cost of the updated first set of employees and a second table corresponding to the second set of employees are created. In an embodiment, the processor 202 may create the first table. In an embodiment, the first table and the second table may correspond to data structures created by the processor 202 in the memory 204. In an embodiment, initially, both the first table and the second table are empty. In an embodiment, the first table is represented as P(i,r), where i corresponds to an employee from the updated first set of employees and r corresponds to the effective headcount associated with the respective employee. In an embodiment, the second table has been represented as E_{c}(i,r).

In an embodiment, the processor 202 may define a range of the headcount value for each skill of the project. In an embodiment, the processor 202 may utilize the threshold value for the second score to define the range of the headcount value. For example, if the first user has defined the second threshold value as 0.25, the range of the headcount value may include values that are multiples of second threshold value. For instance, the range of the headcount value may be {0, 0.25, 0.50, 0.75, 1}.

Thereafter, for each value of the headcount in the range of headcount, the processor 202 utilizes the following condition to populate the first table and the second table for the first employee in the updated first set of employees:
For r ∈ {0, . . . , H}
If r≦r₁, set the first table as P(1,r)=c₁ and the second table as E_{c}(1,r)=1, else the first table as P(1,r)=∞ and the second table as E_{c}(1,r)=0.
For the remaining employees in the updated first set of employees, the processor 202 may utilize the following condition ton populate the first table and the second table:
Set P(i,r)=min(P(i−1,r), cᵢ+P(i−1, max(0,r−rᵢ))) for i ∈ {2, . . . , |E|}, r ∈ {1, . . . , H}. Accordingly, E_{c}(i,r)=0 or 1.
In an embodiment, the above condition depicts the comparison of cost among the updated first set of employees. For example, if the cost of employee (i=1) is less than the cost of employee (i=2), the E_{c}(2,r)=0.

At step 408, the processor 202 may backtrack using the second table to identify the employees having value ‘1’ in the second table. In an embodiment, the employee's having value ‘1’ in the second table constitute the second set of employees. For example, if the E_{c}(2,r)=0 and E_{c}(3,r)=1, third employee (i=3) is selected as the second set of employees. In an embodiment, the second set of employees may comprise one or more copies (each copy correspond to a fraction of employee) of each of the employee from the updated first set of employees.

FIG. 5 is a flowchart 326 illustrating a method for selecting the second set of employees so as to minimize the cost of the project using a time-cost optimization algorithm (hereinafter, FPTAS-Cost algorithm), in accordance with at least one embodiment. The process of selecting the second set of employees and optimizing the cost of the project using the FPTAS-Cost algorithm is described below in conjunction with FIG. 1, FIG. 2, and FIG. 3.

At step 502, the updated first set of employees and the headcount for each of the one or more skills are obtained. In an embodiment, the processor 202 may obtain the updated first set of employees E and the headcount H for each of the one or more skills required for processing the project. In an embodiment, the processor 202 may obtain the modified headcount H for each of the one or more skills required for processing the project, when the first user might have pre-selected one or more employees for processing the project.

In an embodiment, the first user may provide the total cost of the updated first set of employees Cₜₒₜ. The total cost of the updated first set of employees Cₜₒₜ is equal to a sum of the cost of each of the updated first set of employees.

In an embodiment, the processor 202 may choose a random number ε, such that ε|E|<<1. In an embodiment, the first user may provide the value of ε. In an embodiment, the processor 202 may utilize a pre-stored value of ε. For example, The processor 202 may choose

$$ε = \frac{1}{{\vert E \vert}^{c}}$$

for a constant c>0. Given a choice of the tolerance value β by the first user, the processor 202 may choose

$$ε = \frac{1}{{\vert E \vert}^{2 + β}} .$$

At step 504, a first optimal cost of the project is determined. In an embodiment, the processor 202 may determine the first optimal cost of the project C. In an embodiment, the first user may provide first optimal cost of the project C. In an embodiment, the processor 202 may utilize the pre-stored first optimal cost of the project C. In an embodiment, the processor 202 may utilize the pre-stored instructions to determine the first optimal cost of the project. For example,

$$C = \frac{{C}_{tot}}{2} .$$

At step 506, an empty output set is created. In an embodiment, the processor 202 may create the empty output set such as E′_{c}=φ such that E′_{c} ⊂ E. In an embodiment, the empty output set is populated with the second set of employees.

At step 508, the cost of each employee in the updated first set of employees is rounded off using a bucketing procedure. In an embodiment, the processor 202 may round off the cost of each of the first set of employee based on the bucketing procedure. In an embodiment, the processor 202 may create one or more buckets based on the total cost of the updated first set of employees Cₜₒₜ. The number of buckets chosen may depend on the extent of exceeding the first optimal cost of the project. The processor 202 may place each of the updated first set of employees in the one or more buckets based on the cost of each employee. The bucketing procedure is described below:

In an embodiment, the processor 202 may utilize the random number ε>0, such that ε|E|<<1 as discussed above. If the employee i has cost tCε≦cᵢ<(t+1)Cε, the processor 202 may set the rounded cost as c′ᵢ=tCε. In other words, the processor 202 may put it in the t^{th} bucket. The number of such buckets is

$$θ ( \frac{1}{ε} ) .$$

At step 510, a first table corresponding to a contribution (headcount) of the updated first set of employees and a second table corresponding to the second set of employees are created. In an embodiment, the processor 202 may create the first table and the second table. In an embodiment, the first table and the second table may correspond to data structures created by the processor 202 in the memory 204. In an embodiment, initially, both the first table and the second table are empty. In an embodiment, the first table may be represented as R(i,c), where i corresponds to an employee from the updated first set of employees and c corresponds to cost associated with the respective employee. In an embodiment, the second table may be represented as E_{c}(i,c).

The processor 202 utilizes following condition to populate the first table and the second table for the first employee in the updated first set of employees:
For

$$c ∈ \{ 0 , … , ⌈ \frac{1}{ε} ⌉ \}$$

If c′₁≦c, set the first table as R(i,c)=r₁ and the second table as E_{c}(i,c)=1, else the first table as R(i,c)=0 and the second table as E_{c}(i,c)=0.
For the remaining employees in the updated first set of employees, the processor 202 may utilize the following condition ton populate the first table and the second table:
Set R(i,c)=max(R(i−1,c), rᵢ+R(i−1, c−c₁)), when c>c′₁ for i ∈ {2, . . . , |E′|},

$$c ∈ \{ 1 , … , ⌈ \frac{1}{ε} ⌉ \} .$$

Else set the first table as R(i,c)=R(i−1,c), when c≦c′₁ for i ∈ {2, . . . , |E′|},

$$c ∈ \{ 1 , … , ⌈ \frac{1}{ε} ⌉ \} .$$

### Accordingly, E_{c}(i,r)=0 or 1.

At step 512, a check is performed to determine if the guess is feasible. In an embodiment, the processor 202 may perform the check to determine if the guess is feasible. The processor 202 may check, if there exist a set of employees whose total cost may be within the first optimal guess and the total contribution is greater than or equal to the headcount H i.e. R(|E|,C)≧H. If at step 512, the processor 202 determines that R(|E|,C)≧H, step 514 is performed. If at step 512, the processor 202 determines that R(|E|,C)<H, step 516 is performed.

At step 514, a second optimal cost of the project is determined. In an embodiment, the processor 202 may determine the second optimal cost of the project. In an embodiment, the processor 202 may utilize the pre-stored instructions to determine the second optimal cost of the project. For example,

$${C}^{′} = \frac{C}{2} .$$

At step 516, a second optimal cost of the project is determine. In an embodiment, the processor 202 may determine the second optimal cost of the project. In an embodiment, the processor 202 may utilize the pre-stored instructions to determine the second optimal cost of the project. For example,

$${C}^{′} = \frac{3 C}{2} .$$

At step 518, a check is performed to determine if |C′−C| is greater than or equal to 1. If at step 518 the processor 202 determines that |C′−C|≧1, step 520 is performed. If at step 518, the processor 202 determines that |C′−C|<1, step 522 is performed.

At step 520, the first optimal cost of the project is reset. In an embodiment, the processor 202 may set the first set of optimal cost as C=C′. In an embodiment, the processor 202 may repeat the process as discussed above from step 508, when the processor 202 might have set C=C′.

At step 522, the processor 202 may backtrack using the second table to identify the employees having value ‘1’ in the second table. In an embodiment, the employee's having value ‘1’ in the second table constitute the second set of employees. In an embodiment, the second set of employees may comprise one or more copies (each copy correspond to a fraction of employee) of each of the employee from the updated first set of employees.

As discussed above that the updated first set of employees includes copies of the employees that were initially selected in the first set of employees. Therefore, the second set of employees so selected may include one or more copies of the employee. In another embodiment, the second set of employees may not include all the one or more copies of the employee. In such a scenario, the remaining one or more copies of the employee may be staffed on one or more other projects. For example, there are three copies of an employee. Two of the three copies of the employee may be included in the second set of employees. The remaining copy of the employee may still be available to be staffed on another project.

FIG. 6A is a block diagram illustrating a GUI 600A displaying details of an employee, in accordance with an embodiment. The GUI 600A may be displayed on a display screen of a computing device such as the user computing device 102. The first user logs into an employee staffing web application 618 using his/her user id and password. The processor 202 may present the GUI 600A to the first user, when the first user has logged in. The first user may utilize the GUI 600A to view, search, add and edit details of the one or more employees using one or more tabs such as a view tab 614, a search tab 616, and a new tab 612. The GUI 600A may display the information about the employee that may include at least the one or more skills of the employee, the location of the employee, and the EPI of the employee. The GUI 600A may also display the current project allocation of the employee. The processor 202 may allow the first user to edit the details of the employee by clicking on a tab such as an edit tab 622.

FIG. 6B is a block diagram illustrating a GUI 600B utilized by the first user to input the details of the project, in accordance with an embodiment. The processor 202 may present the GUI 600B to the first user, when the first user clicks on a project tab 604. The first user may utilize the GUI 600B to create a new project by clicking on the tab such as the project tab 604 and then a new tab 606 on a menu in the left sidebar as shown in the GUI 600B. The processor 202 may allow the first user to input the information about the project, when the first user clicks on a details tab 628 as shown in the GUI 600B. The first user may utilize the GUI 600B to input at least name of the organization (client), start date for the project, and end date for the project. The processor 202 may allow the first user to input the one or more skills required for processing the project. The first user may input number of employees required for each skill.

FIG. 6C is a block diagram illustrating a GUI 600C utilized by the first user to input the one or more constraints associated with the project, in accordance with an embodiment. The processor 202 may present the GUI 600C to the first user, when the first user may have clicked on the tab such as the project tab 604. The first user may utilize the GUI 600C to input the one or more constraints/rules by clicking on the tab such as a rules tab 638 as shown in the GUI 600C. The processor 202 may utilize the one or more constraints to select the second set of employees who may be staffed on the project. The GUI 600C may be divided into at least one or more sections. The conflicts section may consist of the one or more business constraints associated with the organization/client/project. For example, the client may request that the employees assigned to their IT support should not be allowed to work on projects from a set of other companies. The processor 202 may allow the first user to add more constraints using an add more conflicts tab 648 as shown in the GUI 600C. A minimal fractional requirement 640 section may capture the requirement that any employee assigned to the project should have a minimum fractional allocation equal to the second threshold value, for example say 0.25. A maximum attrition probability 642 section may capture the requirement that any employee assigned to the project should have a maximum attrition probability equal to the first threshold value, for example say 0.30. After filling the one or more sections, the first user clicks on a tab such as a create tab 646 to create the project.

FIG. 6D is a block diagram illustrating a GUI 600D utilized by the first user to staff employees on the project, in accordance with an embodiment. The processor 202 may present the GUI 600D to the first user to staff employees on the project. The first user clicks on a tab such as staff project tab 602 in the menu on the left sidebar as shown in the GUI 600D to staff employees on the project. The GUI 600D may consist of a time-cost slider 654. The first user may utilize the time-cost slider 654 to set the tolerance value. The processor 202 may utilize the position of the slider on the time-cost slider 654 to determine the tolerance value. The first user may be given an option of quickly generating staffing results that might not result in optimal staffing cost (i.e., minimum possible staffing cost) by moving the slider on the time-cost slider towards “Time” end. Alternatively, the first user may obtain staffing results that may take time to generate solution of the project, but may provide optimal staffing cost by moving the slider on the time-cost slider towards “Cost” end. The GUI 600D may consist of tabs such as pre-allocate employee tab 650 and a change attrition probability tab 652 that will be explained in reference with FIG. 6E and FIG. 6F.

FIG. 6E is a block diagram illustrating a GUI 600E utilized by the first user to pre-select the employee for the project, in accordance with an embodiment. The first user clicks on a tab such as a pre-allocate employees tab 650 displayed on the GUI 600D to pre-select the employee of his/her preferences. The processor 202 may present the GUI 600E to the first user, when the first user has clicked on a tab such as the pre-allocate employees tab 650. The GUI 600E may display one or more potential employees (updated first set of employees) for each of the one or more skills required for processing the project. The GUI 600E may allow the first user to select the employee of his/her preferences using a selector 662. The first user may change/modify the skill he/she wants to pre-allocate to the employee. For example, the currently selected skill includes “windows desktop admin (Level 2)”. The first user may click on a link 660 to modify the currently selected skill. On clicking the link 660, the first user may be presented with a drop down list with the one or more skills required by the project. The first user may select one or more required skills from the drop down list.

FIG. 6F is a block diagram illustrating a GUI 600F utilized by the first user to change the attrition probability of the potential employees (updated first set of employees), in accordance with an embodiment. The first user clicks on a tab such as a change attrition probability tab 652 on the GUI 600D to modify the attrition probability of the one or more employees of his/her preferences. The processor 202 may present the GUI 600F to the first user, when the first user has clicked on the change attrition probability tab 652. The GUI 600F may display the one or more potential employees (updated first set of employees) to the first user. The first user may select the employee from the list of potential employees and may change the attrition probability of the selected employee. For example, the first user has worked with the employee ABC1 and feels that the attrition probability (first score) computed by the processor 202 is not accurate. In such a case, the first user clicks on the attrition probability that brings a form as shown in FIG. 6F, where the first user changes the attrition probability of the employee ABC1 from 0.5 to 0.2.

FIG. 6G is a block diagram illustrating a GUI 600G displaying staffing of the employees on the project, in accordance with an embodiment. The first user clicks on a tab such as staff project tab 656 as shown in the GUI 600D to get a team for the project. The selected team for the project is displayed to the first user as shown on the GUI 600G of the user computing device 102. The selected team may have the optimal cost (and may have the suitable tradeoff with the running time of staffing method as chosen in time-cost slider) and may satisfy the one or more constraints imposed by the one or more constraints and the requirements of the project.

Various embodiments of the disclosure lead to a method and a system for staffing the employees on the project. The disclosure incorporates various constraints associated with the project to determine the optimal staffing for the project. The method filter out the employees, based on the attrition history, whose chances of leaving the project is more. The disclosure allows the first user to find the staffing that has minimum cost. Additionally, the disclosure allows the first user to tradeoff the cost of staffing the project with the running time of the project.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C,” “C++,” “Visual C++,” Java, and “Visual Basic.” Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for assigning one or more tasks to one or more workers have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for staffing one or more employees on a project, said method comprising:
selecting, by one or more processors, a first set of employees from said one or more employees for a skill required to process said project, based on at least a first score and a second score, wherein said first score is a measure of attrition likelihood associated with each of said one or more employees for said skill, and wherein said second score corresponds to at least a time expendable by said each of said one or more employees on said project;
receiving, by a transceiver, an input from a computing device deterministic of at least cost of said project, wherein said input is received through a graphical user interface (GUI) presented on said computing device;
selecting, by said one or more processors, a second set of employees from said first set of employees based on at least one of a cost of each employee in said first set of employees, a time duration of said project, and said cost of said project; and
transmitting, by said transceiver, said second set of employees and a cost of staffing said second set of employees on said project to said computing device, wherein said second set of employees is presented on a display screen associated with said computing device through said GUI.

2. The method of claim 1 further comprising determining, by an arithmetic logic unit in said one or more processors, said first score based on an attrition history associated with said each of said one or more employees for said skill, wherein said attrition history comprises at least a log of time spent by an employee on one or more previous projects and a total time allocated to said employee on said one or more previous projects.

3. The method of claim 1 further comprising determining, by an arithmetic logic unit in said one or more processors, said second score based on at least a time available with each of said one or more employees for said project.

4. The method of claim 1 further comprising determining, by an arithmetic logic unit in said one or more processors, a third score for said each of said one or more employees based on a performance and an evaluation history of each of said one or more employees.

5. The method of claim 4 further comprising determining, by said arithmetic logic unit in said one or more processors, a headcount associated with each of said one or more employees based on at least said first score, said second score, and said third score.

6. The method of claim 1 further comprising selecting, by said one or more processors, said first set of employees based on at least one of one or more attributes associated with said project, and historical data associated with each of said one or more employees.

7. The method of claim 6, wherein said one or more attributes associated with said project comprise at least one of said skill required to process said project, a headcount associated with said skill, a location constraint associated with said project, and one or more business constraints associated with an organization.

8. The method of claim 6, wherein said historical data comprises at least one of a performance and an evaluation history, an attrition history, and an allocation history of said one or more employees.

9. The method of claim 1, wherein a first user utilizes said GUI to input at least a first threshold value associated with said first score, and a second threshold value associated with said second score.

10. The method of claim 9, wherein said first user utilizes said GUI to modify at least said first score, and said second score of said first set of employees.

11. The method of claim 9, wherein said first user utilizes said GUI to provide an input deterministic of a pre-selection of an employee from said first set of employees, wherein said second set of employees are selected based on said first score and said second score associated with said pre-selected employee.

12. A system for staffing one or more employees on a project, said system comprising:
a transceiver configured to receive an input from a computing device deterministic of at least a cost of said project, wherein said input is received through a graphical user interface (GUI) presented on said computing device;
one or more processors configured to:
select a first set of employees from said one or more employees for a skill required to process said project, based on at least a first score and a second score, wherein said first score is a measure of attrition likelihood associated with each of said one or more employees for said skill, and wherein said second score corresponds to at least a time expendable by said each of said one or more employees on said project; and
select a second set of employees from said first set of employees based on at least one of a cost of each employee in said first set of employees, a time duration of said project, and said cost of said project.

13. The system of claim 12, wherein an arithmetic logic unit in said one or more processors is configured to determine said first score based on an attrition history associated with each of said one or more employees for said skill, wherein said attrition history comprises at least a log of time spent by an employee on one or more previous projects and a total time allocated to said employee on said one or more previous projects.

14. The system of claim 12, wherein an arithmetic logic unit in said one or more processors is configured to determine said second score based on at least a time available with each of said one or more employees for said project.

15. The system of claim 12, wherein an arithmetic logic unit in said one or more processors is configured to determine a third score for each of said one or more employees based on a performance and an evaluation history of each of said one or more employees.

16. The system of claim 15, wherein said arithmetic logic unit in said one or more processors is further configured to determine a headcount associated with each of said one or more employees based on at least said first score, said second score, and said third score.

17. The system of claim 12, wherein a first user utilizes said GUI to input at least a first threshold value associated with said first score, and a second threshold value associated with said second score.

18. The system of claim 17, wherein said first user utilizes said GUI to provide an input deterministic of a pre-selection of an employee from said first set of employees, wherein said second set of employees are selected based on said first score and said second score associated with said pre-selected employee.

19. The system of claim 12, wherein said transceiver is further configured to transmit said second set of employees and a cost of staffing said second set of employees on said project to said computing device, wherein said second set of employees is presented on a display screen associated with said computing device through said GUI.

20. A computer program product for use with a computer, the computer program product comprising a non-transitory computer readable medium, wherein the non-transitory computer readable medium stores a computer program code for staffing one or more employees on a project, wherein the computer program code is executable by one or more processors to:
select a first set of employees from said one or more employees for a skill required to process said project, based on at least a first score and a second score, wherein said first score is a measure of attrition likelihood associated with each of said one or more employees for said skill, and wherein said second score corresponds to at least a time expendable by each of said one or more employees on said project;
receive, by a transceiver, an input from a computing device deterministic of at least a cost of said project, wherein said input is received through a graphical user interface (GUI) presented on said computing device;
select a second set of employees from said first set of employees based on at least one of a cost of each employee in said first set of employees, a time duration of said project, and said cost of said project; and
transmit, by said transceiver, said second set of employees and a cost of staffing said second set of employees on said project to said computing device, wherein said second set of employees is presented on a display screen associated with said computing device through said GUI.
